(19) United States
(12) Patent Application Publication
(10) Pub. No.: US 2023/0066568 A1
(43) Pub. Date: Mar. 2, 2023

(54) Technique for Allocating Radio Resources

(71) Applicant: Telefonaktiebolaget LM Ericsson (publ), Stockholm (SE)

(72) Inventors: Tai Do, Lund (SE); Peter Alriksson, Hörby (SE); Yuhang Liu, Lund (SE); Jung-Fu Cheng, Fremont, CA (US); Stephen Grant, Pleasanton, CA (US)

(21) Appl. No.: 17/793,964

(22) PCT Filed: Feb. 11, 2021
(86) PCT No.: PCT/SE2021/050103

§ 371 Date: Jul. 20, 2022

Related U.S. Application Data
(60) Provisional application No. 62/977,034, filed on Feb. 14, 2020.

(51) Int. Cl. H04L 5/00; H04L 27/26

(52) U.S. Cl. CPC H04L 5/001; H04L 5/0048; H04L 5/0053; H04L 5/0094; H04L 27/26025

(57) ABSTRACT

A method of allocating radio resources of a radio communication using orthogonal frequency-division multiplexing, OFDM, symbols, OSs is presented. The method includes allocating the radio resources of the radio communication in a time domain in terms of symbol bundles, SBs, where each of the SBs comprising a plurality of OSs.

### TECHNICAL FIELD

The present disclosure relates to allocating radio resources of a radio communication using orthogonal frequency-division multiplexing (OFDM) symbols. More specifically, and without limitation, methods and devices for allocating and applying the allocation of radio resources of a radio communication using OFDM symbols (OSs) and symbol bundles (SBs) are provided.

### BACKGROUND

The Third Generation Partnership Project (3GPP) defines multiple OFDM numerologies (typically labelled by µ=0,1,...), which are supported in New Radio (NR), i.e., for the radio access technology of a radio access network (RAN) for the fifth generation (5G). The subcarrier spacing (SCS) and the cyclic prefix for a carrier bandwidth part are configured by different higher layer parameters for downlink (DL) and uplink (UL), respectively.

Frequency bands for 5G NR are being separated into different frequency ranges. First there is Frequency Range 1 (FR1) includes sub-6 GHz frequency bands, some of which are bands traditionally used by previous standards, but has been extended to cover potential new spectrum offerings from 410 MHz to 7125 MHz. The other is Frequency Range 2 (FR2) that includes frequency bands from 24.25 GHz to 52.6 GHz. For 3GPP Release 16, NR supports subcarrier spacings (SCSs) up to 240 kHz SCS, which can be used for frequency up to 52.6 GHz band. For 3GPP Release 17, 3GPP RAN has agreed on the study item of supporting NR from 52.6 GHz to 71 GHz, e.g. according to the 3GPP Work Item Description (WID) RP-193136.

This WID includes the objective of study of required changes to NR using existing DL/UL NR waveform to support operation between 52.6 GHz and 71 GHz. Particularly, the WID aims at studying applicable numerology including subcarrier spacing, channel BW (including maximum BW), and their impact to the physical layer design in between 52.6 GHz and 71 GHz to support system functionality considering practical RF impairments. Furthermore, potential critical problems to physical signal and/or channels, if any, are to be identified. The WID further aims at studying a channel access mechanism, considering potential interference to and/or from other nodes, assuming beam-based operation, in order to comply with the regulatory requirements applicable to unlicensed spectrum for frequencies between 52.6 GHz and 71 GHz.

In NR, the scheduling or signaling is based on the unit of slot or OFDM symbol. The signaling overhead is depended on the granularity of the scheduling and/or signaling. The finest granularity in NR is one OFDM symbol (OS). As the SCS increases, the OFDM symbol duration decreases. Hence, within a given transmission duration, the number of OS increases.

For higher frequency band using higher SCS (e.g., 960 kHz, i.e., µ = 6, or more), it is not reasonable and not necessary to schedule using units of slots or symbols since the slot is very short. It would put a lot of constraint on hardware implementation as the scheduling and processing time become really short, e.g., in order of several µs. It is beneficial to schedule multiple slots for higher SCS, however the signaling overhead would be very large if the current frame structure and signaling procedure in 3GPP Release 16 for NR are used.

### SUMMARY

Accordingly, there is a need for a technique that efficiently allocates radio resources for a radio communication at different numerologies, e.g., greater SCS.

As to a first method aspect, of allocating radio resources of a radio communication using orthogonal frequency-division multiplexing, OFDM, symbols, OSs (502) is provided. The method comprising allocating the radio resources of the radio communication in a time domain in terms of symbol bundles, SBs, where each of the SBs comprising a plurality of OSs.

In some aspects, a slot comprises a plurality of SBs and each of the SBs comprising a plurality of OSs.

The technique may be implemented as methods to redefine the frame structure and/or signaling procedure for greater (also: “higher”) SCS, in which the frame structure and scheduling and/or signaling are based on a unit of multiple OSs or multiple slots.

By allocating in terms of the SBs, the benefits of an increased SCS can be realized without increasing the signaling overhead in at least some embodiments and/or situations.

As to a second method aspect, a method of applying an allocation of radio resources of a radio communication using orthogonal frequency-division multiplexing, OFDM, symbols, OSs is provided. The method comprising applying the allocation of the radio resources of the radio communication in a time domain in terms of symbol bundles, SBs, where each of the SBs comprising a plurality of OSs.

The first and second method aspect may further comprise any feature and any step disclosed in the context of the first method aspect (particularly any of the embodiments 2 to 40 in the list of embodiments), or a feature or step corresponding thereto, e.g., a receiver counterpart to a transmitter feature or step.

In some aspects, a slot comprises a plurality of SBs and each of the SBs comprising a plurality of OSs.

The first method aspect may be performed at or by a base station. Alternatively or in addition, the second method aspect may be performed by a radio device.

The base station and/or the radio device may form, or may be part of, a radio network, e.g., according to the Third Generation Partnership Project (3GPP) or according to the standard family IEEE 802.11 (Wi-Fi). The first and second method aspects may be performed by one or more embodiments of the base station and the radio device, respectively, in the radio network. The radio network may be a radio access network (RAN). The RAN may comprise one or more base stations, e.g., acting as a transmitting or receiving station. Alternatively or in addition, the radio network may be a vehicular, ad hoc and/or mesh network comprising two or more radio devices.

Any of the radio devices may be a 3GPP user equipment (UE) or a Wi-Fi station (STA). The radio device may be a mobile or portable station, a device for machine-type communication (MTC), a device for narrowband Internet of Things (NB-loT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Any of the radio devices may be wirelessly connected or connectable (e.g., according to a radio resource control, RRC, state or active mode) with any of the base stations.

The base station may encompass any station that is configured to provide radio access to any of the radio devices. The base stations may also be referred to as transmission and reception point (TRP), radio access node or access point (AP). The base station or one of the radio devices functioning as a gateway (e.g., between the radio network and the RAN and/or the Internet) may provide a data link to a host computer providing the first and/or second data. Examples for the base stations may include a 3G base station or Node B, 4G base station or eNodeB, a 5G base station or gNodeB, a Wi-Fi AP and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer and/or a Radio Resource Control (RRC) layer of a protocol stack for the radio communication.

As to another aspect, a computer program product is provided. The computer program product comprises program code portions for performing any one of the steps of the method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

As to a first device aspect, a device for performing the first method aspect is provided. The device may be configured to perform any one of the steps of the first method aspect.

As to a second device aspect, a device for performing the second method aspect is provided. The device may be configured to perform any one of the steps of the second method aspect.

Any of the devices may comprises processing circuitry configured to perform any one of the steps of the respective method aspect.

Any of the devices may comprises at least one processor and a memory. Said memory comprises instructions executable by said at least one processor whereby the device is operative to perform any one of the steps of the respective method aspect.

As to a still further aspect a communication system including a host computer is provided. The host computer comprises a processing circuitry configured to provide user data, e.g., included in the first and/or second data of the multi-layer transmission. The host computer further comprises a communication interface configured to forward the first and/or second data to a cellular network (e.g., the RAN and/or the base station) for transmission to a UE. A processing circuitry of the cellular network is configured to execute any one of the steps of the first and/or second method aspects. The UE comprises a radio interface and processing circuitry, which is configured to execute any one of the steps of the first and/or second method aspects.

The communication system may further include the UE. Alternatively, or in addition, the cellular network may further include one or more base stations configured for radio communication with the UE and/or to provide a data link between the UE and the host computer using the first and/or second method aspects.

The processing circuitry of the host computer may be configured to execute a host application, thereby providing the first and/or second data and/or any host computer functionality described herein. Alternatively, or in addition, the processing circuitry of the UE may be configured to execute a client application associated with the host application.

Any one of the devices, the UE, the base station, the communication system or any node or station for embodying the technique may further include any feature disclosed in the context of the method aspect, and vice versa. Particularly, any one of the units and modules disclosed herein may be configured to perform or initiate one or more of the steps of the method aspect.

A problem solved by the embodiments is that in higher frequency band, a higher subcarrier spacing (SCS) is typically used in an OFDM system in order to reduce impact of phase noise and doppler effect. However, a higher SCS reduces the time duration of a slot, which in state-of-the-art contains 14 symbols and is typically a scheduling unit in NR. The embodiments the unit of a symbol is replaced by another new unit of a symbol-bundle that contains multiple symbols so that each slot now contains 14 symbol-bundles instead of 14 symbols. With such a definition, the slot duration, and hence hardware demand for scheduling, can be maintained the same. Most of the embodiments discusses the potential impacts of this new symbol-bundle radio resource on different signaling structures.

### BRIEF DESCRIPTION OF THE DRAWINGS

Further details of embodiments of the technique are described with reference to the enclosed drawings, wherein:

FIG. 1 shows a schematic block diagram of an embodiment of a device for allocating radio resources of radio resources of a radio communication;

FIG. 2 shows a schematic block diagram of an embodiment of a device for applying an allocation of radio resources of a radio communication;

FIG. 3 shows a flowchart for a method of allocating radio resources of a radio communication, which method may be implementable by the device of FIG. 1;

FIG. 4 shows a flowchart for a method of applying an allocation of radio resources of a radio communication, which method may be implementable by the device of FIG. 2;

FIG. 5 schematically illustrates a reference example of a frame or slot;

FIG. 6 schematically illustrates an embodiment of a frame or slot for implementing the devices of FIGS. 1 and 2;

FIG. 7 schematically illustrates a reference example of a frame or slot;

FIG. 8 schematically illustrates an embodiment of a frame or slot for implementing the devices of FIGS. 1 and 2;

FIG. 9 schematically illustrates a reference example of a frame or slot;

FIG. 10 schematically illustrates an embodiment of a frame or slot for implementing the devices of FIGS. 1 and 2;

FIG. 11 schematically illustrates an embodiment of a frame or slot for implementing the devices of FIGS. 1 and 2;

FIG. 12 schematically illustrates a reference example of a frame or slot;

FIG. 13 schematically illustrates an embodiment of a frame or slot for implementing the devices of FIGS. 1 and 2;

FIG. 14 shows a schematic block diagram of a transmitting station embodying the device of FIG. 1;

FIG. 15 shows a schematic block diagram of a receiving station embodying the device of FIG. 2;

FIG. 16 schematically illustrates an example telecommunication network connected via an intermediate network to a host computer;

FIG. 17 shows a generalized block diagram of a host computer communicating via a base station or radio device functioning as a gateway with a user equipment over a partially wireless connection; and

FIGS. 18 and 19 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including 3GPP LTE (e.g., LTE-Advanced or a related radio access technique such as MulteFire), a Wireless Local Area Network (WLAN) implementation according to the standard family IEEE 802.11, for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

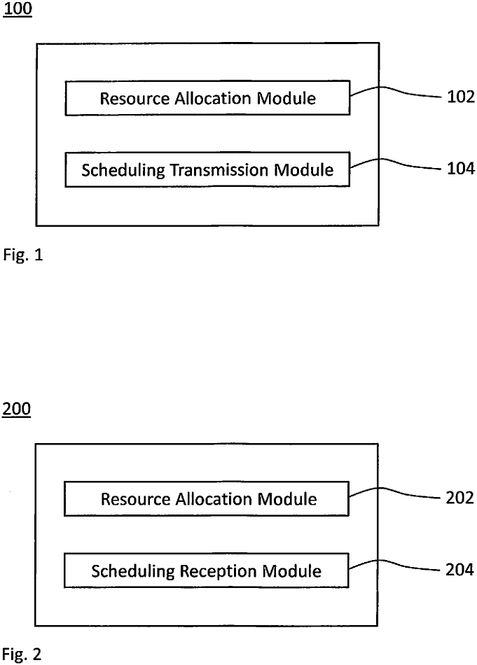

FIG. 1 schematically illustrates a block diagram of a first embodiment of a device for allocating radio resources of a radio communication using orthogonal frequency-division multiplexing (OFDM) symbols (OSs). The device is generically referred to by reference sign 100.

The device 100 comprises a resource allocation module 102 that allocates or initiates allocating the radio resources of the radio communication in a time domain in terms of symbol bundles (SBs). At least one or each of the SBs comprising a plurality of OSs.

Optionally, the device 100 further comprises a scheduling transmission module 104 that transmits or initiates transmitting scheduling information to a radio device in the radio communication. The scheduling information is indicative, in terms of the SBs, of at least one of a beginning, a length, and an ending of a scheduling grant, a scheduling assignment or a transmission opportunity for the radio device in the radio communication.

For example, in the first embodiment, the frame structure for NR rel-16 is redefined for higher SCS (i.e., greater SCS). Greater SCS may encompass an SCS that is greater than 240 kHz.

For example, each slot is defined to comprise (e.g., to consist of) 14 SBs. Such a slot may also be referred to as a super slot. Each of the SBs may also be referred to as super symbols. For example, the super slot comprises 14 symbol bundles (i.e. SBs).

Alternatively or in addition, each super symbol (i.e., each SB) comprises B OFDM symbols. The number B may be an integer greater than 1.

Alternatively or in addition, a mapping of one or more physical signals (e.g., reference signals, RS) for the radio communication and/or a mapping of channel mapping (e.g., PDCCH, PUSCH, and/or PUCCH, etc.) are based on a unit of SB (i.e., in terms of the super symbol). In other words, the SB defines the granularity for mapping physical signals and/or physical channels.

Alternatively or in addition, the scheduling and/or signaling (e.g., control signaling) are based on a unit of SB (i.e., in terms of the super symbol). In other words, the scheduling and/or signaling refers to the SBs for identifying radio resources.

The first embodiment may also be referred to as a main embodiment. Any of the further embodiments may be implemented based on the first embodiment or using a subset of its features.

Any of the modules of the device 100 may be implemented by units configured to provide the corresponding functionality.

The device 100 be embodied by a base station. The base station 100 and the radio device may be in direct radio communication. The radio device may be embodied by the device 200.

FIG. 2 schematically illustrates a block diagram of a first embodiment of a device for applying an allocation of radio resources of a radio communication using OFDM symbols (OSs). The device is generically referred to by reference sign 200.

The device 200 comprises a resource allocation module 202 that applies the allocation of the radio resources of the radio communication in a time domain in terms of symbol bundles (SBs). At least one or each of the SBs comprising a plurality of OSs.

Optionally, the device 200 further comprises a scheduling reception module 204 that receives scheduling information from a base station in the radio communication. The scheduling information is indicative, in terms of the SBs, of at least one of a beginning, a length, and an ending of a scheduling grant, a scheduling assignment or a transmission opportunity for the radio device in the radio communication.

Any of the modules of the device 200 may be implemented by units configured to provide the corresponding functionality.

The device 200 may be embodied by a radio device. The radio device 200 and the base station may be in direct radio communication. The base station may be embodied by the device 200.

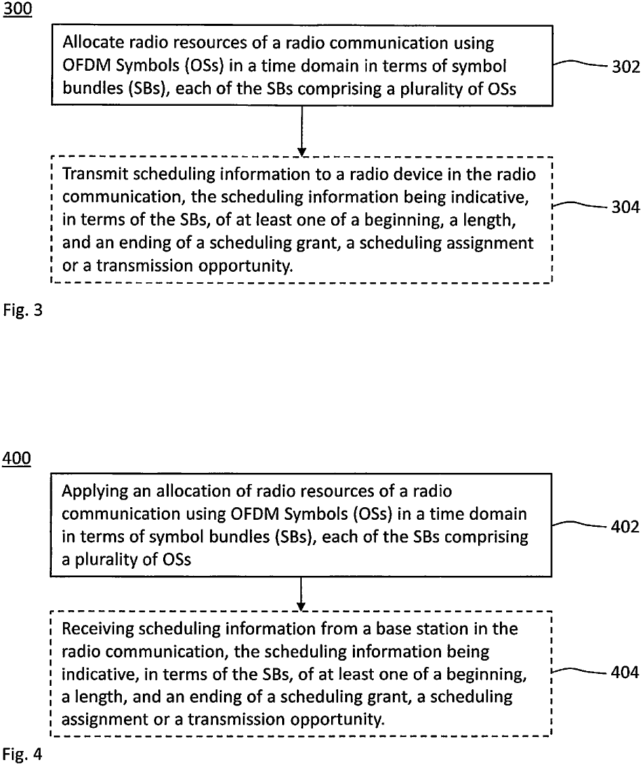

FIG. 3 shows an example flowchart for a method 300 of allocating radio resources of a radio communication using OFDM symbols (OSs). In a step 302, the allocation of the radio resources of the radio communication in a time domain in terms of symbol bundles (SBs) is allocated (e.g., defined), wherein at least one or each of the SBs comprises a plurality of OSs.

Optionally, in a step 304, scheduling information is transmitted from a base station and/or to a radio device in the radio communication. The scheduling information is indicative, in terms of the SBs, of at least one of a beginning, a length, and an ending of a scheduling grant, a scheduling assignment or a transmission opportunity for the radio device.

The method 300 may be performed by the device 100. For example, the modules 102 and 104 may perform the steps 302 and 304, respectively.

FIG. 4 shows an example flowchart for a method 400 of applying an allocation of radio resources of a radio communication using OFDM symbols (OSs). In a step 402, the allocation of the radio resources of the radio communication in a time domain in terms of symbol bundles (SBs) is applied, wherein at least one or each of the SBs comprises a plurality of OSs.

Optionally, in a step 404, scheduling information from a base station in the radio communication is received. The scheduling information is indicative, in terms of the SBs, of at least one of a beginning, a length, and an ending of a scheduling grant, a scheduling assignment or a transmission opportunity.

The method 400 may be performed by the device 200. For example, the modules 202 and 204 may perform the steps 402 and 404, respectively.

In any aspect or embodiment, the radio communication may comprise or use an uplink (UL) communication, a downlink (DL) communication and/or a direct communication between radio devices, e.g., device-to-device (D2D) communications or sidelink (SL) communications.

Each of the device 100 and device 200 may be a radio device or a base station.

Herein, any radio device may be a mobile or portable station and/or any radio device wirelessly connectable to a base station or RAN, or to another radio device. For example, the radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP SL connection.

Furthermore, any base station may be a station providing radio access, may be part of a radio access network (RAN) and/or may be a node connected to the RAN for controlling the radio access. For example, the base station may be an access point, for example a Wi-Fi access point.

In a second embodiment, which may be implementable independently or in combination with the first embodiment, the allocation of the radio resources may depend on, or may be controlled by, a symbol bundling factor.

In one variant of the second embodiment, the number, B, of is selected as power of 2, i.e., B=2ⁿ, wherein n is integer number. Preferably, n=µ so that the duration of each super slot is the same as the duration of a slot (also: “super slot”) with lower SCS (e.g., since SCSs increase as powers of 2). With B equal to 1 the equivalent frame structure as in 3GPP NR Release 16 can be achieved.

In another variant of the second embodiment, B is selected as multiple of 7 so that the duration of each symbol bundle (SB) is the same as the duration of a half or a full slot and/or super slot with a lower SCS (e.g., for µ=0).

The value of B can be specified per physical signal and channel per BWP. For common signals and channels that are relevant to initial channel access when dedicated RRC configuration is not available, the value of B may be specified in the Master Information Block (MIB) and/or one or more relevant System Information Blocks (SIBs), and/or by the specification, or in various of combinations.

Additionally, the B-value for common channels and dedicated channels can be signaled to UEs in dedicated signaling when it is applicable. Furthermore, the B-value for PDSCH and PUSCH can also be dynamically specified in the associated scheduling DCIs or in some MAC CEs.

In a third embodiment, which may be combined with the first and/or the second embodiment, the allocation 302 defines a DM-RS pattern, e.g., for PDSCH and/or PUSCH.

In one variant of the third embodiment, the DM-RS pattern for PDSCH and/or PUSCH in time domain of the frame structure can reuse the DM-RS pattern of NR Release 16 with the scaling factor of B OFDM symbols.

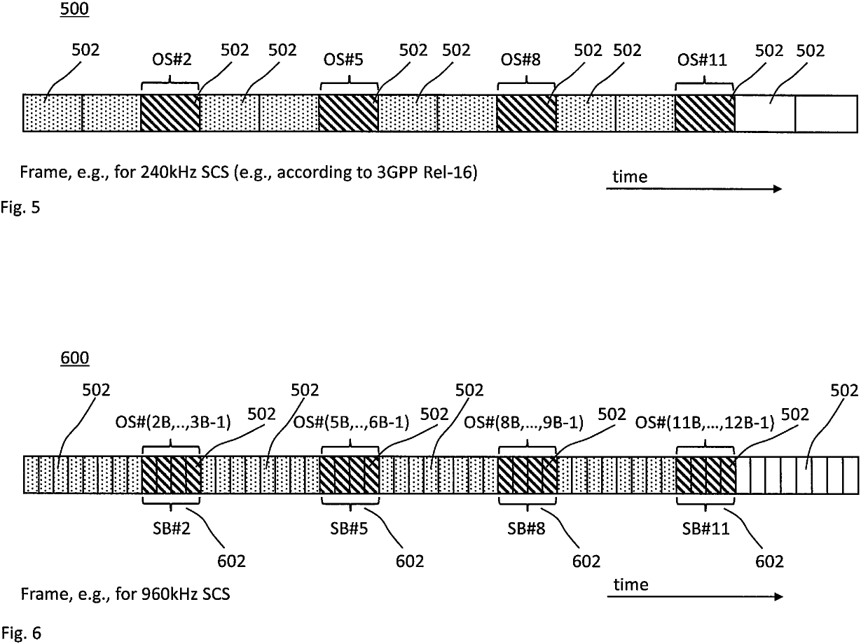

FIG. 5 schematically illustrates a reference example of an existing frame or slot 500, e.g., according to 3GPP Release 16. FIG. 6 schematically illustrates an embodiment of a frame or slot 600 (e.g., a super slot) for extending the existing DM-RS mapping or DM-RS pattern (e.g., of 3GPP Release 16) to the structure based on symbol bundles (SBs) 602.

In the example shown in FIG. 5, e.g., according to the 3GPP Release 16 for the PDSCH and/or the PUSCH with 240 kHz SCS, the DM-RS (shown as a dashed pattern) are mapped in OS 502 numbered 2, 5, 8 and 11 (e.g., out of the 14 OSs 502 numbered from 0 to 13).

Assuming B=4, FIG. 6 schematically illustrates in the frame structure or slot 600 (e.g., for 960 kHz SCS), the corresponding or scaled DM-RS pattern. The DM-RS are mapped in symbol bundles (SBs) 602 with numbers 2, 5, 8 and 11 (e.g., out of the 14 SBs 602 numbered from 0 to 13 in the slot 600).

Each symbol bundle (SB) 602 occupies B (e.g., B = 4) consecutive OFDM symbols, resulting in the DM-RS being mapped and transmitted in B*4 = 16 OSs 502, namely the OS 502 numbered (2B...,3B-1, 5B,...,6B-1,8B,...,9B-1,11B,...,12B-1).

The same signaling mechanism (both layer 1 and higher layers) as in Rel-16 can be reused to signal the DM-RS pattern for PDSCH and/or PUSCH with 960 kHz SCS, with additional information to semi-statically or dynamically specific the value for the symbol bundling factor B.

Alternatively or in addition, the third embodiment is implemented by scaling DM-RS mapping (e.g., for µ=0 and/or for 3GPP Release 16) according to the number B using a frame structure that is based on the symbol bundle (SB) 602.

In another variant of the third embodiment, the DM-RS patterns can be introduced for PDSCH and/or PUSCH transmission by means of symbol bunding. For example, the signaling mechanism for Release 16 may be extended or revised to support the DM-RS patterns on the slot 600.

In a fourth embodiment, which may be combined with any of the first to third embodiments, Symbol bundling is used for other signals and/or other channels.

The fourth embodiment may be implemented using a similar approach to extend from for µ=0 and/or 3GPP Release 16 to a mapping using the symbol bundles (SBs) 602, i.e., an SB-based mapping. The SB-based mapping may be applied for other signal and/or other channel mapping such as Synchronization Signal Block (SSB), CSI-RS, PDCCH, PUCCH, and/or sounding RS (SRS).

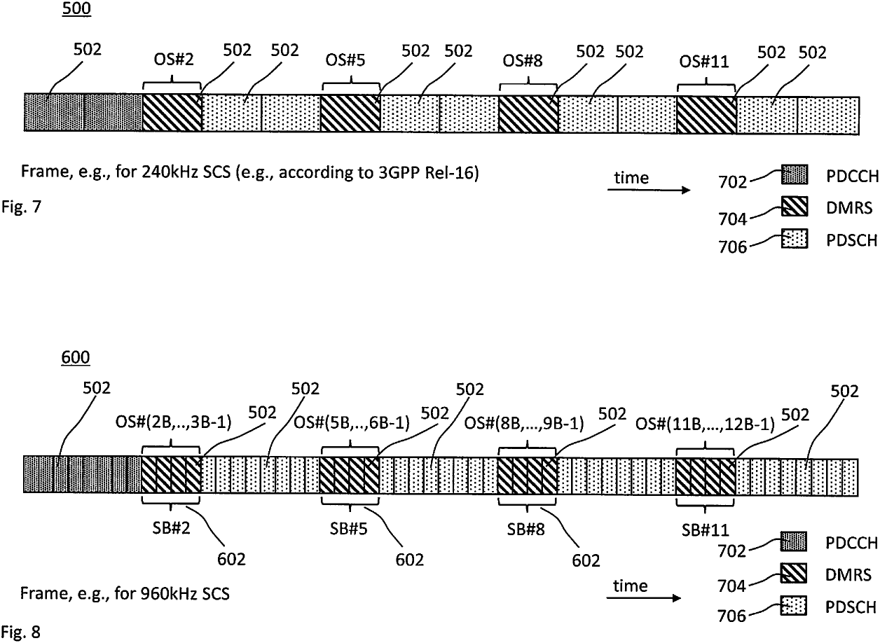

FIGS. 7 and 8 schematically illustrate extending a channel mapping for 3GPP Release 16 (as shown in FIG. 7) to a SB-based frame structure 600 (as shown in FIG. 8).

While FIG. 8 illustrates patterns for PDCCH 702, DM-RS 704 and PDSCH 706, in another variant of the fourth embodiment, the patterns for CSI-RS, PDCCH, PUSCH, PUCCH, etc. are based on the SBs 602. Alternatively or in addition, the patterns for the SB-based slot 600 may be different from the existing patterns for CSI-RS, PDCCH, PUSCH, PUCCH, etc. (e.g., in 3GPP Release 16). For example, the signaling can be a bit different.

A fifth embodiment, which may be combined with any of the first to fourth embodiment uses scheduling and feedback delay.

The scheduling and feedback delays may also be allocated based on symbol bundles (SBs) 602 or super slot 600. The layer 1 (physical layer) and/or higher layer signaling for µ=0 and/or 3GPP Release 16 may be reused, preferably at most as possible. For example, range values may be re-interpreted and/or reduced or extended (e.g., if need).

A sixth embodiment, which may be combined with any of the first to fifth embodiments uses resource mapping.

In one variant of the sixth embodiment, the NR Release 16 principle of mapping modulation symbols to resource elements is reused in the symbol bundling case. For each antenna port used for transmission of any of the physical signals and/or any of the physical channels, one modulation symbol is mapped to one resource element (RE), first over the allocated resource in the frequency domain and then over the allocated OFDM symbols in the time domain.

In another variant of the sixth embodiment, the resource elements (REs) in 3GPP NR Release 16 are re-defined such that each resource element (RE) corresponds to one subcarrier in the frequency domain and B consecutive OSs 502 (i.e., 1 SB 602) in the time domain, which effectively results in repeating a modulation symbol B times in a transmission.

The resource mapping may be performed according to: Time (B OSs) –> frequency -> time (next B OSs)

Alternatively or in combination, the resource mapping be performed (as other way of interpretation): Frequency -> Time (B OSs) -> Frequency -> Time (next B OSs)

Alternatively or in combination, a legacy resource mapping (e.g., according to 3GPP NR Release 16) may be extended (e.g., repeated B times) according to: Time (one OS) -> frequency -> time (next OS)

Scrambling sequences can be imposed on top of the repetition in the time domain to randomize the symbols.

In a seventh embodiment, which is combinable with any of the first to sixth embodiments, enables multiplexing of an antenna port and/or of user multiplexing.

Several signals and/or channels in 3GPP NR Release 16 make use of orthogonal cover codes (OCCs) in either and/or both of the frequency domain and the time domain, e.g., in order to multiplex multiple antenna ports onto the same resource element (RE) or to multiplex the signals from multiple users on the same resource element (RE).

For example for CSI-RS, an OCC of length 2 or 4 is applied across 2 or 4 OFDM symbols (OSs) 502, respectively. If symbol bundling is used with a bundling factor B, at least one of the following two possible approaches may be used to extend the application of OCCs.

A first approach uses symbol spreading. In this approach, the length of the OCC code is increased by a factor of B. This results in increased port/user multiplexing capacity.

In one non-limiting exemplary embodiment, the OCCs are based on Hadamard codes.

If OCC of length 2 is used for the case of no symbol bundling (B = 1), one example of a code of length 2 is [+1, -1]. Then, for the case of symbol bundling with B = 4, the length of the OCC code becomes 8. One example length-8 code is [+1 -1 +1 -1 +1 -1 +1 -1].

A second approach uses block spreading. In this approach, the same length OCC code is used as if B was equal to 1, and the elements of the OCC code are repeated B times. Prior to application of OCCs, the data or reference symbols are repeated B times. In this approach, the port multiplexing and/or user multiplexing capacity is not increased compared to B = 1.

In one non-limiting exemplary embodiment, the OCCs are based on Hadamard codes. If OCC length-2 is used for the case of no symbol bundling (B=1), one example length-2 code is [+1, -1]. Then, for the case of symbol bundling with B = 4, the length of the OCC code becomes 8; however, it is formed by repetition of each element of the length-2 code, i.e., [+1 +1 +1 +1 -1 -1 -1 -1].

In order to break up or randomize the repetition, OCCs can be cycled in the time domain, meaning that a different OCC can be selected from the available codebook of OCCs for each occurrence of the signal and/or channel, e.g., if the signal and/or channel is periodically transmitted every N super slots 600.

In an eighth embodiment 8, which is combinable with any of the first to seventh embodiments, sub-symbol bundles instead of symbol bundle (SB) are used.

The eighth embodiment may be implemented as a variant that applies to all the above embodiments. Instead of defining a symbol bundle (SB or super symbol) 602 as B symbols, each symbol is split into B sub-symbols. Thus, the term symbol bundle in embodiment 1 is replaced with symbol, and the term symbol in embodiment 1 is replaced with sub-symbol.

The reason for these definitions is to make the frame structure redefinition transparent to procedures involving the term or definition of “symbol”.

In the eighth embodiment, a slot may comprise 14 symbols and a symbol may comprise B sub-symbols. A sub-symbol comprises a cyclic prefix and an OFDM symbol.

In the first embodiment, a slot may comprise 14 symbol bundles and a symbol bundle may comprise B symbols. A symbol comprises a cyclic prefix and an OFDM symbol.

Below table summarizes the differences or definitions of the embodiments.

| | | | |
|---|---|---|---|
| | Rel-16 | Embodiment 1 | Embodiment 8 |
| Slot | 14 symbols | 14 symbol bundles | 14 symbols |
| Symbol bundle | - | B symbols | - |
| Symbol | CP + OFDM symbol | CP + OFDM symbol | B sub-symbols |
| Sub-symbol | - | - | CP + OFDM symbol |

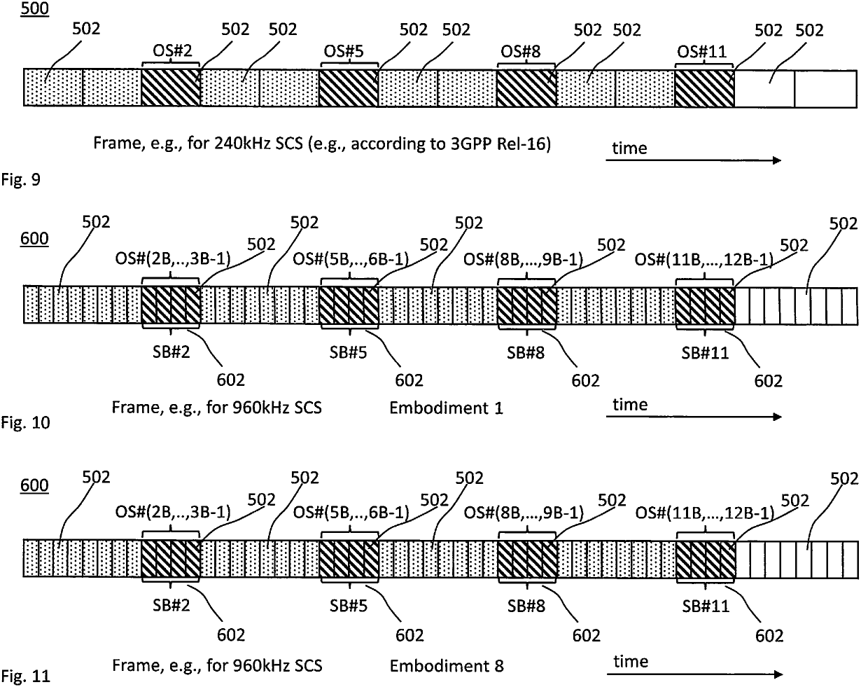

The differences between an existing frame or slot 500 (e.g., according to 3GPP Release 16), a frame or slot 600 according to the embodiment 1 and the embodiment 8 are also illustrated in FIGS. 9, 10 and 11, respectively.

In a ninth embodiment, which may be implemented as a variant of any of the above embodiments, symbol bundle sizes for different channel and signal are used.

As variants of above embodiments, the mapping and signaling for different signal and channel can be based on different units (e.g., granularity) scaling from B, e.g., unit of B1=alpha1*B OSs for DMRS, unit of B2=alpha_2*B OSs for PUCCH and so on, wherein B1, B2,.., are integer numbers which could be larger or smaller than B.

There may be a tradeoff between scheduling flexibility and signaling overhead for different signal and channels. For example, larger Bᵢ may provide less scheduling flexibility but requires less signaling overhead.

One example of the embodiment, the DM-RS symbol does not scale-up in the same way as data symbol for PDSCH/PUSCH with symbol bundling. In this case, the symbol bundling factor for DMRS (B_{DMRS}) takes a different value than the symbol bundling factor B for PDSCH and/or PUSCH.

For example, B_{DMRS} is normally smaller than or equal to B. When B_{DMRS} is smaller than B, the remaining (B - B_{DMRS}) OFDM symbols in the same symbol bundle can be used for mapping of other symbols, which includes, but is not limited to, PDSCH/PUSCH data, CSI-RS (in DL) and/or SRS (in UL).

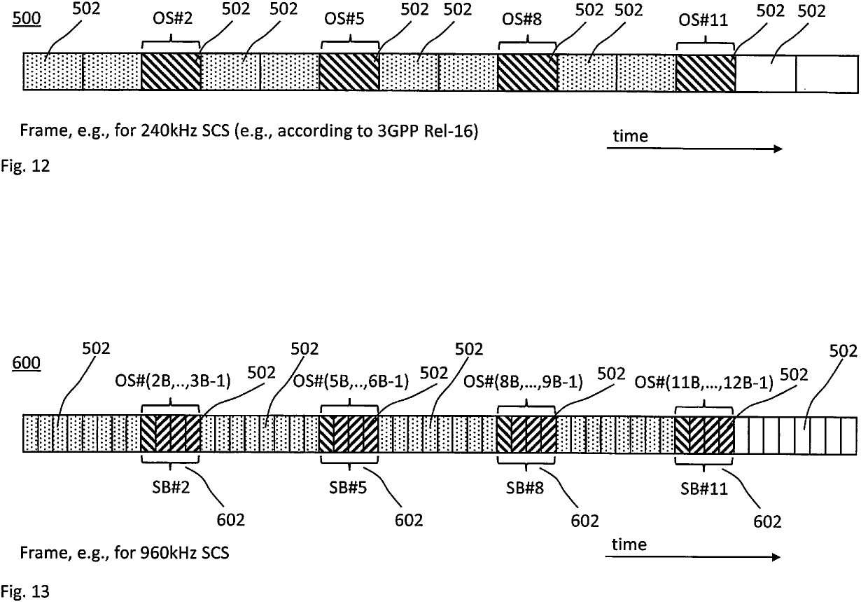

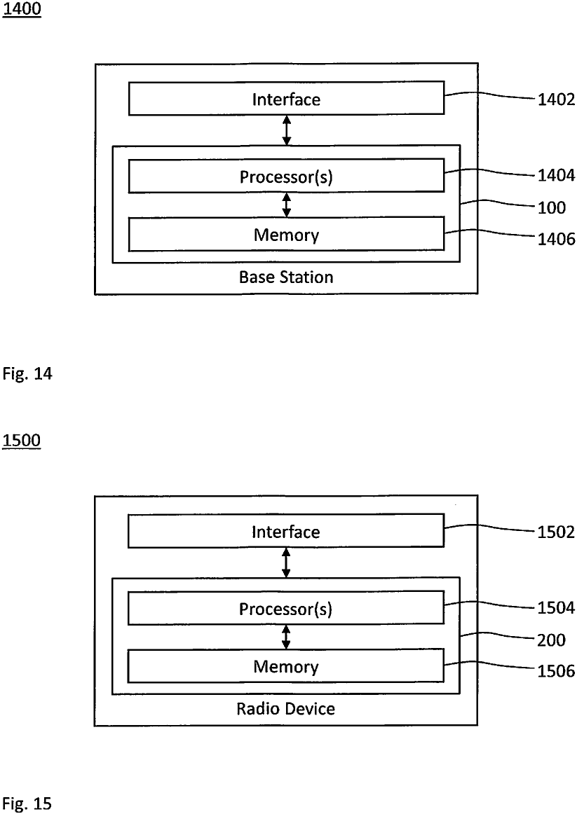

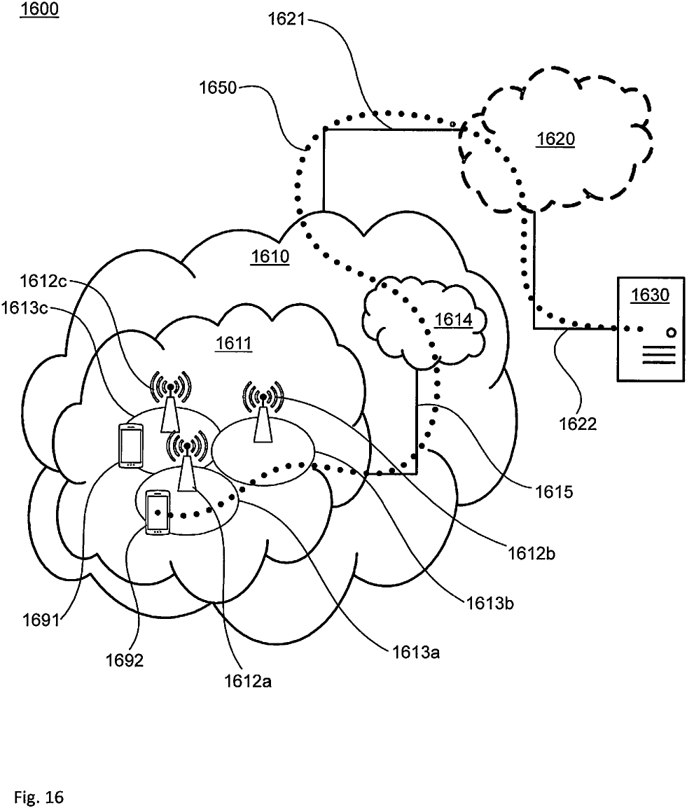

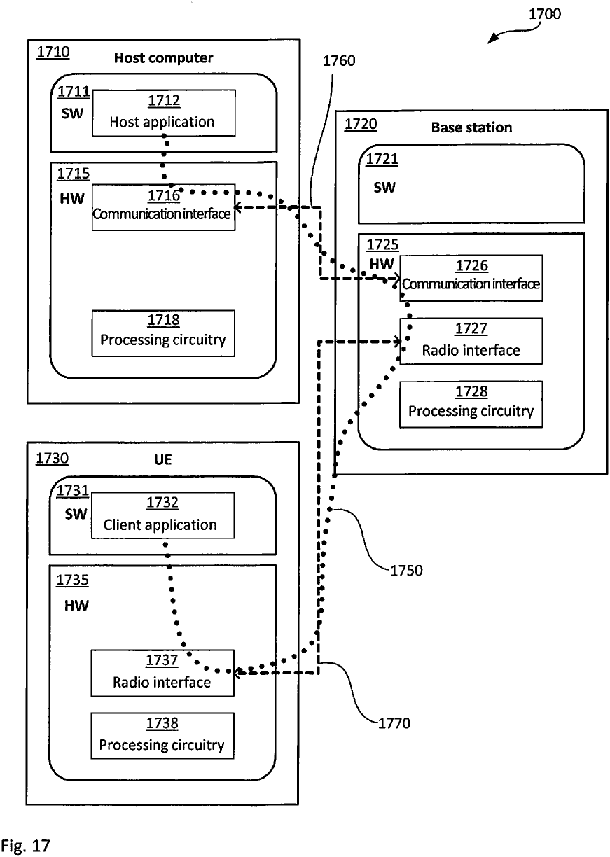

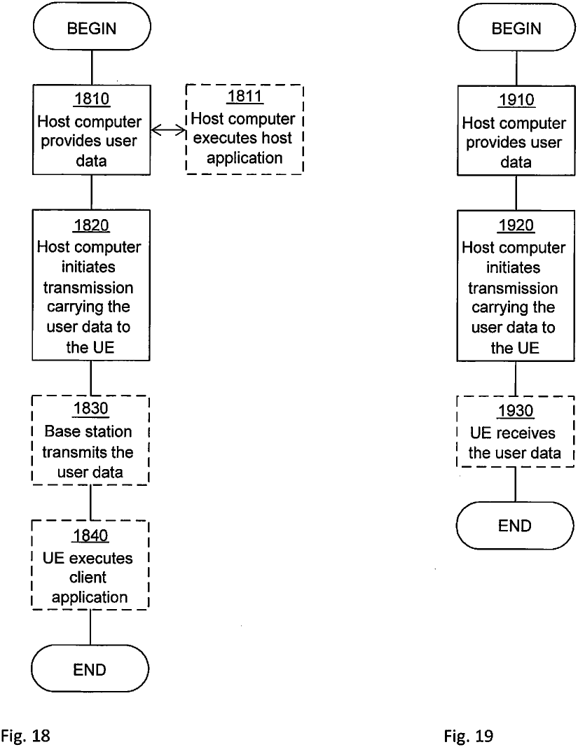

FIGS. 12 and 13 demonstrates such a case in that DM-RS symbol does not scale-up in the same way as the data symbols, leaving 3 OFDM symbols (dashed from bottom left to top right) available for other resource mapping, e.g., further data.

Alternatively or in addition, the ninth embodiment may be implemented by using one OS 502 in a SBs 602 to partly comprise DM-RS symbols.

Any embodiment may be applied to 3GPP NR numerologies with µ>4. The multiple OFDM numerologies, µ, may be supported in NR as given by he below table for µ=0, ..., 4, wherein the subcarrier spacing, Δf_{SCS}, and the cyclic prefix for a carrier bandwidth part are configured by different higher layer parameters for downlink and uplink, respectively.

| | | | | | |
|---|---|---|---|---|---|
| Subcarrier spacing (SCS) Δf_{SCS}, e.g., Δƒ_{SCS} = 2^{µ} · 15 kHz | 15 kHz | 30 kHz | 60 kHz | 120 kHz | 240 kHz |
| Slot duration (e.g., 1 ms / 2^{µ}) | 1000 µs | 500 µs | 250 µs | 125 µs | 62.5 µs |
| Duration of OFDM symbol (e.g., ⅟Δƒ) | 66.67 µs | 33.33 µs | 16.67 µs | 8.33 µs | 4.17 µs |
| Duration of cyclic prefix | 4.69 µs | 2.34 µs | 1.17 µs | 0.59 µs | 0.29 µs |
| Length T_{symb}^{of} OFDM symbol including cyclic prefix | 71.35 µs | 35.68 µs | 17.84 µs | 8.92 µs | 4.46 µs |
| Maximum carrier bandwidth, also: maximum channel bandwidth (e.g., for 4000 FFT components or subcarriers) | 50 MHz | 100 MHz | 200 MHz | 400 MHz | 800 MHz |

The case µ=0 may correspond to 3GPP LTE.

Any embodiment may be implemented according to NR an 3GPP agreement on supporting NR from 52.6 GHz to 71 GHz, particularly, for greater SCSs proposed for supporting NR from 52.6 GHz to 71 GHz, e.g., Δf = 960 kHz or more.

The technique may be combined with a slot structure for NR consisting of 14 OFDM symbols.

The technique may use super slot that may be classified as either UL, DL or Flexible to accommodate DL/UL transient period and both DL and UL transmissions.

The technique may be combined slot variations for the super slots, e.g., by extending mini-slots (also referred to as Type B PDSCH/PUSCH mapping in 3GPP specifications) to the super slots. For example, mini-super slots may be shorter than super slots and/or may start at any SB. Mini-super slots may be used if the transmission duration of a super slot is too long or the occurrence of the next slot start (slot alignment) is too late. Applications of mini-slots include among others latency critical transmissions (in this case both mini-slot length and frequent opportunity of mini-slot are important) and unlicensed spectrum, wherein a transmission should start immediately after listen-before-talk (LBT) succeeded (here the frequent opportunity of mini-super slot may be especially important).

Hereinbelow, reference to Fig. X means X-5 and reference signs XXYY mean (XX-5)YY.

FIG. 19 shows a schematic block diagram for an embodiment of the device 100. The device 100 comprises one or more processors 1904 for performing the method 300 and memory 1906 coupled to the processors 1904. For example, the memory 1906 may be encoded with instructions that implement at least one of the modules 102 and 104.

The one or more processors 1904 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 1906, base station functionality. For example, the one or more processors 1904 may execute instructions stored in the memory 1906. Such functionality may include providing various features and steps discussed herein, including any of the benefits disclosed herein. The expression “the device being operative to perform an action” may denote the device 100 being configured to perform the action.

As schematically illustrated in FIG. 19, the device 100 may be embodied by a base station 1900, e.g., functioning as a transmitting base station or a transmitting UE. The base station 1900 comprises a radio interface 1902 coupled to the device 100 for radio communication with one or more radio devices, e.g., functioning as a base station.

FIG. 20 shows a schematic block diagram for an embodiment of the device 200. The device 200 comprises one or more processors 2004 for performing the method 400 and memory 2006 coupled to the processors 2004. For example, the memory 2006 may be encoded with instructions that implement at least one of the modules 202 and 204.

The one or more processors 2004 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 2006, radio device functionality. For example, the one or more processors 2004 may execute instructions stored in the memory 2006. Such functionality may include providing various features and steps discussed herein, including any of the benefits disclosed herein. The expression “the device being operative to perform an action” may denote the device 200 being configured to perform the action.

As schematically illustrated in FIG. 20, the device 200 may be embodied by a radio device 2000, e.g., functioning as a UE. The radio device 2000 comprises a radio interface 2002 coupled to the device 200 for radio communication with one or more base stations.

With reference to FIG. 21, in accordance with an embodiment, a communication system 2100 includes a telecommunication network 2110, such as a 3GPP-type cellular network, which comprises an access network 2111, such as a radio access network, and a core network 2114. The access network 2111 comprises a plurality of base stations 2112a, 2112b, 2112c, such as NBs, eNBs, gNBs or other types of wireless access points, each defining a corresponding coverage area 2113a, 2113b, 2113c. Each base station 2112a, 2112b, 2112c is connectable to the core network 2114 over a wired or wireless connection 2115. A first user equipment (UE) 2191 located in coverage area 2113c is configured to wirelessly connect to, or be paged by, the corresponding base station 2112c. A second UE 2192 in coverage area 2113a is wirelessly connectable to the corresponding base station 2112a. While a plurality of UEs 2191, 2192 are illustrated in this example, the disclosed embodiments are equally applicable to a situation where a sole UE is in the coverage area or where a sole UE is connecting to the corresponding base station 2112.

Any of the base stations 2112 and the UEs 2191, 2192 may embody the device 100.

The telecommunication network 2110 is itself connected to a host computer 2130, which may be embodied in the hardware and/or software of a standalone server, a cloud-implemented server, a distributed server or as processing resources in a server farm. The host computer 2130 may be under the ownership or control of a service provider, or may be operated by the service provider or on behalf of the service provider. The connections 2121, 2122 between the telecommunication network 2110 and the host computer 2130 may extend directly from the core network 2114 to the host computer 2130 or may go via an optional intermediate network 2120. The intermediate network 2120 may be one of, or a combination of more than one of, a public, private or hosted network; the intermediate network 2120, if any, may be a backbone network or the Internet; in particular, the intermediate network 2120 may comprise two or more sub-networks (not shown).

The communication system 2100 of FIG. 21 as a whole enables connectivity between one of the connected UEs 2191, 2192 and the host computer 2130. The connectivity may be described as an over-the-top (OTT) connection 2150. The host computer 2130 and the connected UEs 2191, 2192 are configured to communicate data and/or signaling via the OTT connection 2150, using the access network 2111, the core network 2114, any intermediate network 2120 and possible further infrastructure (not shown) as intermediaries. The OTT connection 2150 may be transparent in the sense that the participating communication devices through which the OTT connection 2150 passes are unaware of routing of uplink and downlink communications. For example, a base station 2112 need not be informed about the past routing of an incoming downlink communication with data originating from a host computer 2130 to be forwarded (e.g., handed over) to a connected UE 2191. Similarly, the base station 2112 need not be aware of the future routing of an outgoing uplink communication originating from the UE 2191 towards the host computer 2130.

By virtue of the method 200 being performed by any one of the UEs 2191 or 2192 and/or any one of the base stations 2112, the performance of the OTT connection 2150 can be improved, e.g., in terms of increased throughput and/or reduced latency. More specifically, the host computer 2130 may indicate the AC 302 for the user data being a piece of the data in the multi-layer transmission 208.

Example implementations, in accordance with an embodiment of the UE, base station and host computer discussed in the preceding paragraphs, will now be described with reference to FIG. 22. In a communication system 2200, a host computer 2210 comprises hardware 2215 including a communication interface 2216 configured to set up and maintain a wired or wireless connection with an interface of a different communication device of the communication system 2200. The host computer 2210 further comprises processing circuitry 2218, which may have storage and/or processing capabilities. In particular, the processing circuitry 2218 may comprise one or more programmable processors, application-specific integrated circuits, field programmable gate arrays or combinations of these (not shown) adapted to execute instructions. The host computer 2210 further comprises software 2211, which is stored in or accessible by the host computer 2210 and executable by the processing circuitry 2218. The software 2211 includes a host application 2212. The host application 2212 may be operable to provide a service to a remote user, such as a UE 2230 connecting via an OTT connection 2250 terminating at the UE 2230 and the host computer 2210. In providing the service to the remote user, the host application 2212 may provide user data, which is transmitted using the OTT connection 2250. The user data may depend on the location of the UE 2230. The user data may comprise auxiliary information or precision advertisements (also: ads) delivered to the UE 2230. The location may be reported by the UE 2230 to the host computer, e.g., using the OTT connection 2250, and/or by the base station 2220, e.g., using a connection 2260.

The communication system 2200 further includes a base station 2220 provided in a telecommunication system and comprising hardware 2225 enabling it to communicate with the host computer 2210 and with the UE 2230. The hardware 2225 may include a communication interface 2226 for setting up and maintaining a wired or wireless connection with an interface of a different communication device of the communication system 2200, as well as a radio interface 2227 for setting up and maintaining at least a wireless connection 2270 with a UE 2230 located in a coverage area (not shown in FIG. 22) served by the base station 2220. The communication interface 2226 may be configured to facilitate a connection 2260 to the host computer 2210. The connection 2260 may be direct, or it may pass through a core network (not shown in FIG. 22) of the telecommunication system and/or through one or more intermediate networks outside the telecommunication system. In the embodiment shown, the hardware 2225 of the base station 2220 further includes processing circuitry 2228, which may comprise one or more programmable processors, application-specific integrated circuits, field programmable gate arrays or combinations of these (not shown) adapted to execute instructions. The base station 2220 further has software 2221 stored internally or accessible via an external connection.

The communication system 2200 further includes the UE 2230 already referred to. Its hardware 2235 may include a radio interface 2237 configured to set up and maintain a wireless connection 2270 with a base station serving a coverage area in which the UE 2230 is currently located. The hardware 2235 of the UE 2230 further includes processing circuitry 2238, which may comprise one or more programmable processors, application-specific integrated circuits, field programmable gate arrays or combinations of these (not shown) adapted to execute instructions. The UE 2230 further comprises software 2231, which is stored in or accessible by the UE 2230 and executable by the processing circuitry 2238. The software 2231 includes a client application 2232. The client application 2232 may be operable to provide a service to a human or non-human user via the UE 2230, with the support of the host computer 2210. In the host computer 2210, an executing host application 2212 may communicate with the executing client application 2232 via the OTT connection 2250 terminating at the UE 2230 and the host computer 2210. In providing the service to the user, the client application 2232 may receive request data from the host application 2212 and provide user data in response to the request data. The OTT connection 2250 may transfer both the request data and the user data. The client application 2232 may interact with the user to generate the user data that it provides.

It is noted that the host computer 2210, base station 2220 and UE 2230 illustrated in FIG. 22 may be identical to the host computer 2130, one of the base stations 2112a, 2112b, 2112c and one of the UEs 2191, 2192 of FIG. 21, respectively. This is to say, the inner workings of these entities may be as shown in FIG. 22, and, independently, the surrounding network topology may be that of FIG. 21.

In FIG. 22, the OTT connection 2250 has been drawn abstractly to illustrate the communication between the host computer 2210 and the UE 2230 via the base station 2220, without explicit reference to any intermediary devices and the precise routing of messages via these devices. Network infrastructure may determine the routing, which it may be configured to hide from the UE 2230 or from the service provider operating the host computer 2210, or both. While the OTT connection 2250 is active, the network infrastructure may further take decisions by which it dynamically changes the routing (e.g., on the basis of load balancing consideration or reconfiguration of the network).

The wireless connection 2270 between the UE 2230 and the base station 2220 is in accordance with the teachings of the embodiments described throughout this disclosure. One or more of the various embodiments improve the performance of OTT services provided to the UE 2230 using the OTT connection 2250, in which the wireless connection 2270 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 2250 between the host computer 2210 and UE 2230, in response to variations in the measurement results. The measurement procedure and/or the network functionality for reconfiguring the OTT connection 2250 may be implemented in the software 2211 of the host computer 2210 or in the software 2231 of the UE 2230, or both. In embodiments, sensors (not shown) may be deployed in or in association with communication devices through which the OTT connection 2250 passes; the sensors may participate in the measurement procedure by supplying values of the monitored quantities exemplified above, or supplying values of other physical quantities from which software 2211, 2231 may compute or estimate the monitored quantities. The reconfiguring of the OTT connection 2250 may include message format, retransmission settings, preferred routing etc.; the reconfiguring need not affect the base station 2220, and it may be unknown or imperceptible to the base station 2220. Such procedures and functionalities may be known and practiced in the art. In certain embodiments, measurements may involve proprietary UE signaling facilitating the host computer’s 2210 measurements of throughput, propagation times, latency and the like. The measurements may be implemented in that the software 2211, 2231 causes messages to be transmitted, in particular empty or “dummy” messages, using the OTT connection 2250 while it monitors propagation times, errors etc.

FIG. 23 is a flowchart illustrating a method implemented in a communication system, in accordance with one embodiment. The communication system includes a host computer, a base station and a UE which may be those described with reference to FIGS. 21 and 22. For simplicity of the present disclosure, only drawing references to FIG. 23 will be included in this paragraph. In a first step 2310 of the method, the host computer provides user data. In an optional substep 2311 of the first step 2310, the host computer provides the user data by executing a host application. In a second step 2320, the host computer initiates a transmission carrying the user data to the UE. In an optional third step 2330, the base station transmits to the UE the user data which was carried in the transmission that the host computer initiated, in accordance with the teachings of the embodiments described throughout this disclosure. In an optional fourth step 2340, the UE executes a client application associated with the host application executed by the host computer.

FIG. 24 is a flowchart illustrating a method implemented in a communication system, in accordance with one embodiment. The communication system includes a host computer, a base station and a UE which may be those described with reference to FIGS. 21 and 22. For simplicity of the present disclosure, only drawing references to FIG. 24 will be included in this paragraph. In a first step 2410 of the method, the host computer provides user data. In an optional substep (not shown) the host computer provides the user data by executing a host application. In a second step 2420, the host computer initiates a transmission carrying the user data to the UE. The transmission may pass via the base station, in accordance with the teachings of the embodiments described throughout this disclosure. In an optional third step 2430, the UE receives the user data carried in the transmission.

As has become apparent from above description, embodiments of the technique allow for improved methods that can be used to reduce the signaling overhead in higher frequency band, preferably while minimize the impact on existing specifications, e.g. for a radio frame structure and/or allocating physical channels and/or physical signals.

At least some embodiments allow allocating radio resources at SCS greater than 240 kHz and/or for a numerology greater than µ=4 and/or for NR using a radio frequency from 52.6 GHz to 71 GHz. Same or further embodiments can be implemented according to 3GPP standard document TS 38.211, TS 38.212, TS 38.213, and/or TS 38.331.

Any of the embodiments may be implemented at a radio device (e.g., a UE) and/or a base station (e.g., a gNB). Alternatively or in addition, any of the embodiments may be implemented in a baseband of the respective device.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should may be implemented, limited or defined (e.g., only) by the scope of the list of embodiments.

### LIST OF EMBODIMENTS

1. A method (300) of allocating radio resources of a radio communication using orthogonal frequency-division multiplexing, OFDM, symbols, OSs (502), the method (300) comprising or initiating:

allocating (302) the radio resources of the radio communication in a time domain in terms of symbol bundles, SBs (602), wherein a slot compris a plurality of SBs and each of the SBs (602) comprising a plurality of OSs (502).

Herein, OS may refer to “OFDM symbol”, and OSs may refer to “OFDM symbols”. Furthermore, SB may refer to “symbol bundle”, and SBs may refer to “symbol bundles”.

Allocating the radio resources in terms of the SBs may encompass, or may be implemented by, allocating the radio resources in units or multiples of the SBs. Analogously, allocating radio resources in terms of the OSs may encompass, or may be implemented by, allocating the radio resources in units or multiples of the SBs.

Each of the SBs may be referred to as a super symbol.

2. The method (300) of embodiment 1, wherein the number of OSs (502) comprised in each of the SBs (602) is related to, or proportional to, a subcarrier spacing, SCS, of the OSs (502).

The SCS may be defined by a SCS type or numerology of the radio communication.

For example, the same base station and/or the radio communication may use different SCSs at different times or different base stations of the same radio access network (RAN) may use different SCSs. The different SCSs may be used in combination with different numbers of OSs comprised in each SBs.

Herein, the term base station may be used interchangeably with the term cell. The RAN may be a cellular RAN.

3. The method (300) of embodiment 1 or 2, wherein the number of OSs (502) comprised in each of the SBs (602) is inversely related to, or inversely proportional to, a length of each of the OSs (502).

For example, the same base station and/or the radio communication may use different lengths of the OSs (e.g., different numerologies) at different times or different base stations of the same RAN may use different lengths of the OSs. The different lengths of the OSs may be used in combination with different numbers of OSs comprised in each SBs.

Herein, a length may be a length in the time domain or a duration.

4. The method (300) of any one of embodiments 1 to 3, wherein each of the SBs (602) comprises the same number of OSs (502).

For example, each of the SBs in the same frequency band and/or each of the SBs allocated (e.g., scheduled) by the same base station may comprise the same number of OSs.

5. The method (300) of any one of embodiments 1 to 4, wherein each of the SBs (602) comprises B OSs (502), wherein B is an integer number equal to or greater than 2.

For example, B = 7 or 14.

6. The method (300) of any one of embodiments 1 to 5, wherein each of the SBs (602) comprises B OSs (502), wherein B is a power of two.

For example, B = 2^{µ} (i.e., B is 2 to the power of µ).

7. The method (300) of any one of embodiments 1 to 6, wherein the radio communication uses a first frequency band and a second frequency band, a carrier frequency of the first frequency band being less than a carrier frequency of the second frequency band, and wherein the radio resources of the second frequency band are allocated (202) in terms of the SBs (602), and the radio resources of the first frequency band are allocated in terms of the OSs (502).

A numerology of the first frequency band may be different from a numerology of the second frequency band. For example, a SCS of the OSs in the first frequency band may less than a SCS of the OSs in the second frequency band. Alternatively or in addition, a length of the OSs in the first frequency band may greater than a length of the OSs in the second frequency band.

The first frequency band and a second frequency band may be nonoverlapping or disjoint. The first frequency band and the second frequency band may be aggregated carriers, e.g., component carriers of a carrier aggregation (CA) used by the radio communication.

The first frequency band and the second frequency band may be noncontiguous in a frequency domain. For example, the first frequency band and the second frequency band may belong to different operating frequency bands. The first frequency band and the second frequency band may be an inter-band CA.

8. The method (300) of embodiment 7, wherein a length of each of the SBs (602) in the second frequency band may correspond to, or may be equal to, a length of each of the OSs (502) in the first frequency band.

9. The method (300) of embodiment 7 or 8, wherein edges of the SBs (602) in the second frequency band are aligned with edges of the OSs (502) in the first frequency band.

Each of the edges may be a boundary (e.g., a beginning or an ending) of the respective SB or OS.

10. The method (300) of any one of embodiments 7 to 9, wherein radio resources allocated in the first frequency band comprise a physical channel and/or a physical signal that starts at an n-th OS in the first frequency band, and wherein the radio resources allocated in the second frequency band comprise the physical channel and/or the physical signal
at an n-th SB in the second frequency band and/or
from an (n·B)-th OS to an ((n+1)·B-1)-th OS in the second frequency band, wherein each of the SBs (602) in the second frequency band comprises B OSs (502).

The n-th OS and the n-th SB may be numbered relative to (e.g., a beginning of) a radio frame for both the first frequency band and the second frequency band. The numbering may start with the 0-th OS or the 0-th SB.

11. The method (300) of any one of embodiments 7 to 10, wherein the carrier frequency of the first frequency band is less than 50 GHz, and/or wherein the carrier frequency of the second frequency band is greater than 50 GHz, and/or wherein a SCS of the OSs (502) in the first frequency band is equal to or less than 240 kHz, and/or wherein a SCS of the OSs (502) in the second frequency band is greater than 240 kHz.

12. The method (300) of any one of embodiments 1 to 11, wherein the radio resources are allocated in units or multiples of one or more of the SBs (602).

13. The method (300) of any one of embodiments 1 to 12, wherein the radio communication uses different numerologies, different SCSs and/or different lengths of the OSs (502), and wherein a length of the SBs (602) is independent of the numerology, the SCS and/or the length of the OS.

14. The method of any one of embodiments 1 to 13, wherein the method (300) is performed by a base station in radio communication with a radio device.

The base station may be any radio node configured to allocate the radio resources for the radio communication. A radio access network may comprise the base station or multiple embodiments of the base station. The base station or each of the base stations may be configured to perform the first method aspect and/or provide radio access to the radio device for the radio communication.

The scheduling of the radio communication may comprise at least one of transmitting a scheduling grant for a radio transmission in the radio communication and transmitting a scheduling assignment for a radio reception in the radio communication.

15. The method of embodiment 14, wherein the method (300) or the allocating (302) of the radio resources of the radio communication comprises or initiates:

transmitting (304) scheduling information to the radio device, the scheduling information being indicative, in terms of the SBs (602), of at least one of a beginning, a length, and an ending of a scheduling grant, a scheduling assignment or a transmission opportunity.

16. The method (300) of any one of embodiments 1 to 15, wherein the allocating of the radio resources comprises at least one of:
mapping one or more physical channels (702; 706) to the radio resources in terms of the SBs (602);
mapping one or more physical signals (704) to the radio resources in terms of the SBs (602);
scheduling the radio resources of the radio communication in terms of the SBs (602);
control signaling in the radio communication is based on the SBs (602); and
defining a radio frame structure and/or a slot (600) of the radio communication in the time domain in terms of the SBs (602).

17. The method (300) of embodiment 16, wherein the one or more physical channels comprises at least one of a Physical Downlink Control Channel, PDCCH (702); a Physical Uplink Control Channel, PUCCH; a Physical Downlink Shared Channel (706); and a Physical Uplink Shared Channel.

18. The method (300) of embodiment 16 or 17, wherein the one or more physical signals comprise at least one of reference signals, RS (704); and random access preambles, RAP.

19. The method (300) of embodiment 18, wherein the RS comprise at least one of demodulation RS, DM-RS (704); a channel state information RS, CSI-RS; and phase tracking RS, PT-RS.

20. The method (300) of any one of embodiment 16 to 19, wherein the radio frame structure and/or the slot (600) is defined by a number of SBs (602).

21. The method (300) of embodiment 20, wherein the number of SBs (602) defining the radio frame structure and/or the slot (600) is independent of a numerology of the radio communication, a SCS of the OSs (502) and/or a length of the OSs (502).

The slot defined in terms of the SBs may be referred to as a super slot. The number of SBs defining the slot may be 7 or 14.

22. The method (300) of any one of embodiments 1 to 21, further comprising at least one of:

modulating, transmitting, demodulating and receiving each of the OSs (502) within at least one or each of the SBs (602).

23. The method (300) of any one of embodiments 1 to 22, wherein the allocating (302) comprises specifying and/or transmitting a number of OSs (502) comprised in each SBs (602) by means of a physical signal, on a physical channel and/or per bandwidth part, BWP.

24. The method (300) of any one of embodiments 1 to 23, wherein the allocating (302) comprises specifying and/or transmitting a number of OSs (502) comprised in each SBs (602) by means of a Master Information Block, MIB, and/or one or more System Information Blocks, preferably during initial channel access.

25. The method (300) of any one of embodiments 1 to 24, wherein the allocating (302) comprises specifying and/or transmitting a number of OSs (502) comprised in each SBs (602) for one or more common channels and/or for one or more dedicated channels to a radio device (100) using dedicated signaling, preferably radio resource control, RRC, signaling.

26. The method (300) of any one of embodiments 1 to 25, wherein the allocating (302) comprises specifying and/or transmitting a number of OSs (502) comprised in each SBs (602) for a physical downlink shared channel, PDSCH, and/or a physical uplink shared channel, PUSCH, dynamically using at least one of downlink control information, DCI, and/or one or more Medium Access Control, MAC, control elements, CEs.

27. The method (300) of any one of embodiments 1 to 26, wherein the allocating (302) comprises transmitting scheduling information that is indicative of a number of OSs (502) comprised in each SBs (602).

28. The method (300) of any one of embodiments 1 to 27, wherein the allocating (302) comprises specifying and/or transmitting a pattern of reference signals, preferably DM-RSs (704).

29. The method (300) of embodiment 28, wherein the pattern of the reference signals (704) is, up to scaling by the number of OSs (502) comprised in each SBs (602), independent of at least one of a numerology, a SCS and a length of the OSs (502) used in the radio communication.

30. The method (300) of any one of embodiments 1 to 29, wherein each SB (602) occupies a plurality of consecutive OSs (502).

31. The method (300) of any one of embodiments 1 to 30, wherein the same signaling mechanism, preferably at least on the physical layer 1, is used for different numerologies, different SCSs and or different lengths of the OSs (502) to transmit a pattern of RS (704).

32. The method (300) of any one of embodiments 1 to 31, wherein the allocating (302) comprises mapping physical signals (704) and/or physical channel (702; 706) to the radio resources using a frame structure that is based on the SBs (602) as a generalization or replacement for the OSs (502).

33. The method (300) of any one of embodiments 1 to 32, wherein the allocation (302) comprises or initiates mapping modulation symbols to resource elements, REs, wherein for each antenna port used for transmitting or receiving a physical signal or a physical channel, one modulation symbol is mapped to one RE over the allocated radio resources in the frequency domain and over the allocated OSs (502) comprised in the respective SB (602) in the time domain.

34. The method (300) of any one of embodiments 1 to 33, wherein the method (300) or the allocating (302) comprises transmitting a signal by mapping a modulation symbol representing the signal in the time domain over the plurality of OSs (502) comprised in one SB (602) or consecutive SBs (602).

35. The method (300) of any one of embodiments 1 to 35, wherein the method (300) or the allocating (302) comprises transmitting a physical signal by mapping the same modulation symbol to each of the plurality of OSs (502) comprised in one SB (602) or consecutive SBs (602).

36. The method (300) of embodiment 34 or 35, wherein at least one of a scrambling sequence, an orthogonal cover code, OCC, and a Hadamard code is imposed in the time domain on the plurality of OSs (502) comprised in the one SB (602) or the consecutive SBs (602).

37. The method (300) of embodiment 36, wherein a length of scrambling sequence, the OCC or the Hadamard code is scaled by the number of OSs (502) comprised in one SB.

38. The method (300) of any one of embodiments 1 to 37, wherein the allocation (302) comprises different numbers of OSs (502) comprised in each of the SBs (602) for different physical signals and/or for different physical channels and/or for data.

39. The method (300) of embodiment 38, wherein the numbers of OSs (502) comprised in each of the SBs (602) is less for RSs (704) as compared to data, preferably compared to PUSCH and/or PDSCH.

40. The method (300) of embodiment 38 or 39, wherein OSs (502) in a SBs (602) are partly allocated to RSs (704) and partly allocated to data, preferably to PUSCH and/or PDSCH.

41. A method (400) of applying an allocation of radio resources of a radio communication using orthogonal frequency-division multiplexing, OFDM, symbols, OSs (502), the method (400) comprising or initiating:

applying (402) the allocation of the radio resources of the radio communication in a time domain in terms of symbol bundles, SBs (602), each of the SBs (602) comprising a plurality of OSs (502).

42. The method of embodiment 41, wherein the method (400) or the applying (402) of the allocation of the radio resources of the radio communication comprises or initiates:

receiving (404) scheduling information from a base station in the radio communication, the scheduling information being indicative, in terms of the SBs (602), of at least one of a beginning, a length, and an ending of a scheduling grant, a scheduling assignment or a transmission opportunity.

43. The method of embodiment 41 or 42, further comprising the steps of any one of embodiments 2 to 40 or a step corresponding thereto.

44. A computer program product comprising program code portions for performing the steps of any one of the embodiments 1 to 40 or 41 to 43 when the computer program product is executed on one or more computing devices (1404; 1504), optionally stored on a computer-readable recording medium (1406; 1506).

45. A radio device (200) comprising memory operable to store instructions and processing circuitry operable to execute the instructions, such that the radio device (200) is operable to perform any of the steps of embodiments 41 to 43.

46. A radio device (200), configured to perform the steps of any one of embodiments 41 to 43.

47. A user equipment, UE, (200; 1500; 1391; 1392; 1430) configured to communicate with a base station (100; 1400; 1312; 1420) or radio device functioning as a gateway, the UE (100; 1100; 1391; 1392; 1430) comprising a radio interface (1502; 1437) and processing circuitry (1504; 1438) configured to execute the steps of any one of embodiments 41 to 43.

48. A network node (100; 1400) comprising memory operable to store instructions and processing circuitry operable to execute the instructions, such that the network node (100; 1400) is operable to perform any of the steps of embodiment 1 to 40.

49. A network node (100; 1400) configured to perform the steps of any one of embodiment 1 to 40.

50. A base station (100; 1400; 1312; 1420) configured to communicate with a user equipment, UE (200; 1500), the base station (100; 1400; 1312; 1420) comprising a radio interface (1402; 1427) and processing circuitry (1404; 1428) configured to execute the steps of any one of embodiment 1 to 40.

51. A communication system (1300; 1400) including a host computer (1330; 1410) comprising:
processing circuitry (1418) configured to provide user data; and
a communication interface (1416) configured to forward user data to a cellular or ad hoc radio network (1310) for transmission to a user equipment, UE, (100; 1100; 1391; 1392; 1430) wherein the UE (100; 1100; 1391; 1392; 1430) comprises a radio interface (1102; 1437) and processing circuitry (1104; 1438), the processing circuitry (1104; 1438) of the UE (100; 1100; 1391; 1392; 1430) being configured to execute the steps of any one of embodiments 41 to 43.

52. The communication system (1300; 1400) of embodiment 51, further including the UE (200; 1500; 1391; 1392; 1430).

53. The communication system (1300; 1400) of embodiment 51 or 52, wherein the radio network (1310) further comprises a base station (100; 1400; 1312; 1420) or radio device (100; 1100; 1391; 1392; 1430) functioning as a gateway configured to communicate with the UE (200; 1500; 1391; 1392; 1430).

54. The communication system (1300; 1400) of embodiment 53, wherein the base station (100; 1400; 1312; 1420) or the radio device (100; 1100; 1391; 1392; 1430) functioning as a gateway comprises processing circuitry (1204; 1428) being configured to execute the steps of embodiment 1 to 40.

55. The communication system (1300; 1400) of any one of embodiments 51 to 54, wherein:
the processing circuitry (1418) of the host computer (1330; 1410) is configured to execute a host application (1412), thereby providing the user data; and
the processing circuitry (1104; 1438) of the UE (200; 1500; 1391; 1392; 1430) is configured to execute a client application (1432) associated with the host application (1412).

1-51. (canceled)

52. A method of allocating radio resources of a radio communication using Orthogonal Frequency-Division Multiplexing (OFDM) symbols (OSs), the method comprising:
allocating the radio resources of the radio communication in a time domain in terms of Symbol Bundles (SBs), wherein a slot comprises a plurality of SBs and each of the SBs comprises a plurality of OSs.

53. The method of claim 52, wherein the number of OSs comprised in each of the SBs is related to, or proportional to, a subcarrier spacing (SCS) of the OSs.

54. The method of claim 52, wherein the number of OSs comprised in each of the SBs is inversely related to, or inversely proportional to, a length of each of the OSs.

55. The method of claim 52, wherein each of the SBs comprises a same number of OSs.

56. The method of claim 52, wherein each of the SBs comprises an integer number of OSs equal to a power of two.

57. The method of claim 52, wherein:
the radio communication uses a first frequency band and a second frequency band;
a carrier frequency of the first frequency band is less than a carrier frequency of the second frequency band;
the radio resources of the second frequency band are allocated in terms of the SBs; and
the radio resources of the first frequency band are allocated in terms of the OSs.

58. The method of claim 57, wherein a length of each of the SBs in the second frequency band may correspond to, or may be equal to, a length of each of the OSs in the first frequency band.

59. The method of claim 57, wherein the second frequency band comprises a frequency band between 52.6 GHz and 71 GHz.

60. The method of claim 57, wherein:
the radio resources allocated in the first frequency band comprise a physical channel
and/or a physical signal that starts at an n-th OS in the first frequency band; and
the radio resources allocated in the second frequency band comprise:
the physical channel and/or the physical signal at an n-th SB in the second frequency band; and/or
a number of OSs equal to a power of two in each of the SBs.

61. The method of claim 57, wherein:
the carrier frequency of the first frequency band is less than 50 GHz; and/or
the carrier frequency of the second frequency band is greater than 50 GHz; and/or
an SCS of the OSs in the first frequency band is equal to or less than 240 kHz; and/or
an SCS of the OSs in the second frequency band is greater than 240 kHz.

62. The method of claim 52, wherein:
the radio communication uses different numerologies, different SCSs, and/or different lengths of the OSs; and
a length of the SBs is independent of the numerology, the SCS, and/or the length of the OS.

63. The method of claim 52, wherein the method is performed by a base station in radio communication with a radio device.

64. The method of claim 63, wherein the method further comprises:
transmitting scheduling information to the radio device, the scheduling information being indicative, in terms of the SBs, of at least one of a beginning, a length, and an ending of a scheduling grant, a scheduling assignment, or a transmission opportunity.

65. The method of claim 52, wherein the allocating of the radio resources comprises at least one of:
mapping one or more physical channels to the radio resources in terms of the SBs;
mapping one or more physical signals to the radio resources in terms of the SBs;
scheduling the radio resources of the radio communication in terms of the SBs;
control signaling in the radio communication is based on the SBs; and
defining a radio frame structure and/or a slot of the radio communication in the time domain in terms of the SBs.

66. The method of claim 65, wherein the one or more physical signals comprise at least one of reference signals (RSs) and random access preambles (RAPs).

67. The method of claim 66, wherein the RSs comprise at least one of demodulation RSs (DM-RSs), channel state information RSs (CSI—RSs), and phase tracking RSs (PT—RSs).

68. The method of claim 65, wherein the radio frame structure and/or the slot is defined by a number of SBs.

69. The method of claim 68, wherein the number of SBs defining the radio frame structure and/or the slot is independent of a numerology of the radio communication, an SCS of the OSs, and/or a length of the OSs.

70. A network node comprising:
processing circuitry and a memory, the memory containing instructions executable by the processing circuitry whereby the network node is configured to allocate radio resources of a radio communication in a time domain in terms of Symbol Bundles (SBs);
wherein a slot comprises a plurality of SBs and each of the SBs comprises a plurality of OSs.

71. A non-transitory computer readable medium storing a computer program for controlling a network node, the computer program comprising instructions which, when executed on processing circuitry of the network node, cause the network node to:
allocate radio resources of a radio communication in a time domain in terms of Symbol Bundles (SBs), wherein a slot comprises a plurality of SBs and each of the SBs comprises a plurality of OSs.
